(19) United States
(12) Patent Application Publication
(10) Pub. No.: US 2025/0133498 A1
(43) Pub. Date: Apr. 24, 2025

(54) WAKE-UP SIGNAL MONITORING METHOD AND APPARATUS, WAKE-UP SIGNAL MONITORING INDICATION METHOD AND APPARATUS, TERMINAL, AND NETWORK SIDE DEVICE

(71) Applicant: VIVO MOBILE COMMUNICATION CO., LTD., Dongguan (CN)

(72) Inventors: Dongru LI, Dongguan (CN); Xiaodong SHEN, Dongguan (CN)

(73) Assignee: VIVO MOBILE COMMUNICATION CO., LTD., Dongguan (CN)

(21) Appl. No.: 19/006,175

(22) Filed: Dec. 30, 2024

Related U.S. Application Data
(63) Continuation of application No. PCT/CN2023/105415, filed on Jun. 30, 2023.

(30) Foreign Application Priority Data
Jul. 20, 2022 (CN) 202210861692.3

(51) Int. Cl. H04W 52/02; H04W 68/02

(52) U.S. Cl. CPC H04W 52/0229; H04W 52/0216; H04W 68/02

(57) ABSTRACT

This application provides a wake-up signal monitoring method and apparatus, a wake-up signal monitoring indication method and apparatus, a terminal, and a network side device. The wake-up signal monitoring method includes: determining, by a terminal, wake-up signal monitoring time information based on first information; and monitoring, by the terminal, a wake-up signal based on the wake-up signal monitoring time information. The wake-up signal includes a low power wake-up signal. The first information includes at least one of the following parameters: time unit configuration information; wake-up signal configuration information of the terminal; wake-up signal monitoring unit configuration information; beacon signal configuration information; reference time configuration information; monitoring relationship configuration information; paging information; or a first time offset.

### CROSS-REFERENCE TO RELATED APPLICATIONS

This application is a continuation of International Application No. PCT/CN 2023/105415, filed on Jun. 30, 2023, which claims priority to Chinese Patent Application No. 202210861692.3, filed on Jul. 20, 2022. The entire contents of each of the above-referenced applications are expressly incorporated herein by reference.

### TECHNICAL FIELD

This application pertains to the field of communication technologies, and specifically, to a wake-up signal monitoring method and apparatus, a wake-up signal monitoring indication method and apparatus, a terminal, and a network side device.

### BACKGROUND

In a mobile communication system, how to reduce power consumption of a terminal is a critical technical problem. In a solution, the terminal monitors a Low Power Wake-Up Signal (LP-WUS) to determine whether there is a transmission requirement of a communication service currently. However, because of a large quantity of terminals, a case that a terminal is falsely waked up in a process of detecting an LP-WUS may occur.

### SUMMARY

Embodiments of this application provide a wake-up signal monitoring method and apparatus, a wake-up signal monitoring indication method and apparatus, a terminal, and a network side device.

According to a first aspect, a wake-up signal monitoring method is provided, including:
determining, by a terminal, wake-up signal monitoring time information based on first information; and
monitoring, by the terminal, a wake-up signal based on the wake-up signal monitoring
time information, where the wake-up signal includes a low power wake-up signal; and
the first information includes at least one of the following parameters:
time unit configuration information;
wake-up signal configuration information of the terminal;
wake-up signal monitoring unit configuration information;
beacon signal configuration information;
reference time configuration information;
monitoring relationship configuration information;
paging information; and
a first time offset.

According to a second aspect, a wake-up signal monitoring apparatus is provided, where the apparatus is applied to a terminal and includes:
a determining module, configured to determine wake-up signal monitoring time information based on first information; and
a monitoring module, configured to monitor a wake-up signal based on the wake-up signal monitoring time information, where the wake-up signal includes a low power wake-up signal; and
the first information includes at least one of the following parameters:
time unit configuration information;
wake-up signal configuration information of the terminal;
wake-up signal monitoring unit configuration information;
beacon signal configuration information;
reference time configuration information;
monitoring relationship configuration information;
paging information; and
a first time offset.

According to a third aspect, a wake-up signal monitoring indication method is provided, including:
sending, by a network side device, first information to a terminal, where the first information is used by the terminal to determine wake-up signal monitoring time information, and the wake-up signal includes a low power wake-up signal; and
the first information includes at least one of the following parameters:
time unit configuration information;
wake-up signal configuration information of the terminal;
wake-up signal monitoring unit configuration information;
beacon signal configuration information;
reference time configuration information;
monitoring relationship configuration information;
paging information; and
a first time offset.

According to a fourth aspect, a wake-up signal monitoring indication apparatus is provided, where the apparatus is applied to a network side device and includes:
a sending module, configured to send first information to a terminal, where the first information is used by the terminal to determine wake-up signal monitoring time information, and the wake-up signal includes a low power wake-up signal; and
the first information includes at least one of the following parameters:
time unit configuration information;
wake-up signal configuration information of the terminal;
wake-up signal monitoring unit configuration information;
beacon signal configuration information;
reference time configuration information;
monitoring relationship configuration information;
paging information; and
a first time offset.

According to a fifth aspect, a terminal is provided. The terminal includes a processor and a memory, the memory stores a program or an instruction that can be run on the processor, and the program or the instruction is executed by the processor to implement the steps of the method according to the first aspect.

According to a sixth aspect, a terminal is provided, including a processor and a communication interface. The processor is configured to determine wake-up signal monitoring time information based on first information; and the communication interface is configured to monitor a wake-up signal based on the wake-up signal monitoring time information, where
the first information includes at least one of the following parameters:
time unit configuration information;
wake-up signal configuration information of the terminal;
wake-up signal monitoring unit configuration information;
beacon signal configuration information;
reference time configuration information;
monitoring relationship configuration information;
paging information; and
a first time offset.

According to a seventh aspect, a network side device is provided. The network side device includes a processor and a memory, the memory stores a program or an instruction that can be run on the processor, and the program or the instruction is executed by the processor to implement the steps of the method according to the third aspect.

According to an eighth aspect, a network side device is provided, including a processor and a communication interface. The communication interface is configured to send first information to a terminal, where the first information is used by the terminal to determine wake-up signal monitoring time information; and
the first information includes at least one of the following parameters:
time unit configuration information;
wake-up signal configuration information of the terminal;
wake-up signal monitoring unit configuration information;
beacon signal configuration information;
reference time configuration information;
monitoring relationship configuration information;
paging information; and
a first time offset.

According to a ninth aspect, a communication system is provided, including a terminal and a network side device. The terminal may be configured to perform the steps of the wake-up signal monitoring method according to the first aspect, and the network side device may be configured to perform the steps of the wake-up signal monitoring indication method according to the third aspect.

According to a tenth aspect, a readable storage medium is provided. The readable storage medium stores a program or an instruction, and the program or the instruction is executed by a processor to implement the steps of the method according to the first aspect or the third aspect.

According to an eleventh aspect, a chip is provided. The chip includes a processor and a communication interface, the communication interface is coupled to the processor, and the processor is configured to run a program or an instruction to implement the method according to the first aspect or the third aspect.

According to a twelfth aspect, a computer program/program product is provided. The computer program/program product is stored in a storage medium, and the computer program/program product is executed by at least one processor to implement the steps of the method according to the first aspect or the third aspect.

In the embodiments of this application, a terminal determines wake-up signal monitoring time information of the terminal based on first information, and then the terminal monitors a wake-up signal based on the wake-up signal monitoring time information. Therefore, the terminal can monitor a wake-up signal in a monitoring time corresponding to the terminal, and does not need to monitor a wake-up signal in an entire time domain.

### BRIEF DESCRIPTION OF DRAWINGS

FIG. 1 is a block diagram of a wireless communication system to which the embodiments of this application can be applied;

FIG. 2 is a schematic diagram of a working principle of an NR LP WUR/WUS;

FIG. 3 is a schematic diagram of a time domain pattern of On-Off-Keying;

FIG. 4 is a schematic diagram of a frame structure of a beacon signal;

FIG. 5 is a schematic flowchart of a wake-up signal monitoring method according to an embodiment of this application;

FIG. 6 is a schematic diagram of periodicities of different terminals in an application case 1;

FIG. 7 is a schematic diagram of monitoring by a terminal when monitoring duration of a beacon signal overlaps monitoring duration of an LP-WUS in a time domain;

FIG. 8 is a schematic diagram of wake-up signal periodicities of different terminals in an application case 2;

FIG. 9 is a schematic diagram of a state of monitoring a wake-up signal by a terminal in an application case 3;

FIG. 10 is a schematic diagram of information exchange between a main communication module and a low power receiving module in a terminal;

FIG. 11 is a schematic module diagram of a wake-up signal monitoring apparatus according to an embodiment of this application;

FIG. 12 is a schematic structural diagram of a terminal according to an embodiment of this application;

FIG. 13 is a schematic flowchart of a wake-up signal monitoring indication method according to an embodiment of this application;

FIG. 14 is a schematic module diagram of a wake-up signal monitoring indication apparatus according to an embodiment of this application;

FIG. 15 is a schematic structural diagram of a network side device according to an embodiment of this application; and

FIG. 16 is a schematic structural diagram of a communication device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th Generation (6G) communication system.

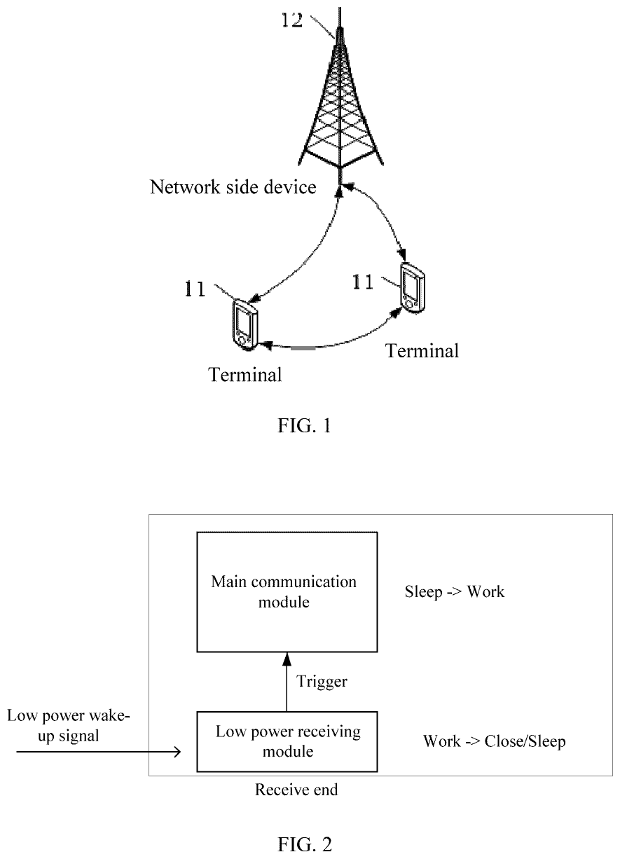

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a Radio Access Network (RAN), a radio access network function, or a radio access network unit. The access network device may include a base station, a Wireless Local Area Network (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. As long as a same technical effect is achieved, the base station is not limited to a specified technical term. It should be noted that, in this application, only a base station in an NR system is used as an example, and a specific type of the base station is not limited.

The following describes related nouns in the embodiments of this application as follows.

### 1. Low Power Receiver

The low power receiver is a low power wake-up receiver (Low Power Wake Up Radio (LP-WUR)). A basic working principle of the LP-WUR is that a receive end includes a first module and a second module. For example, as shown in FIG. 2, the first module is a main communication module, configured to receive and send mobile communication data, and the second module is a low power receiving module (also referred to as a low power wake-up receiving module), configured to receive a wake-up signal. In an energy-saving state, the terminal enables the low power receiving module to monitor an LP-WUS and disables the main communication module. When downlink data arrives, a network sends a wake-up signal to the terminal. After monitoring the wake-up signal through the low power receiving module, the terminal triggers, after a series of judgments, the main communication module from being disabled to being enabled, and the low power receiving module enters a disable state from a working state in this case. The low power wake-up receiving module may be continuously enabled or intermittently enabled, and may receive a low power wake-up signal when enabled.

### 2. Low Power Wake-Up Signal (LP-WUS)

To reduce receiving activity of the terminal in a standby state, a Radio Frequency (RF) module and a baseband (MODEM) module are truly disabled, thereby greatly reducing power consumption of communication receiving; and a near “zero” power receiver may be introduced into a receiving module of the terminal to implement this. This near “zero” power receiver does not require signal detection (for example, amplification, filtering, and quantization) of a complex RF module and signal processing of a modulator-demodulator Modulator-Demodulator (MODEM), but only relies on passive matching filtering and signal processing with less power consumption.

On a base station side, a wake-up signal is triggered on-demand, and the terminal receives an LP-WUS by using a wake-up receiver (Wake Up Radio (WUR)). In this way, the near “zero” power receiver may be activated to learn an activation notification, thereby triggering a series of procedures inside the terminal, for example, enabling a radio frequency transceiver and a baseband processing module.

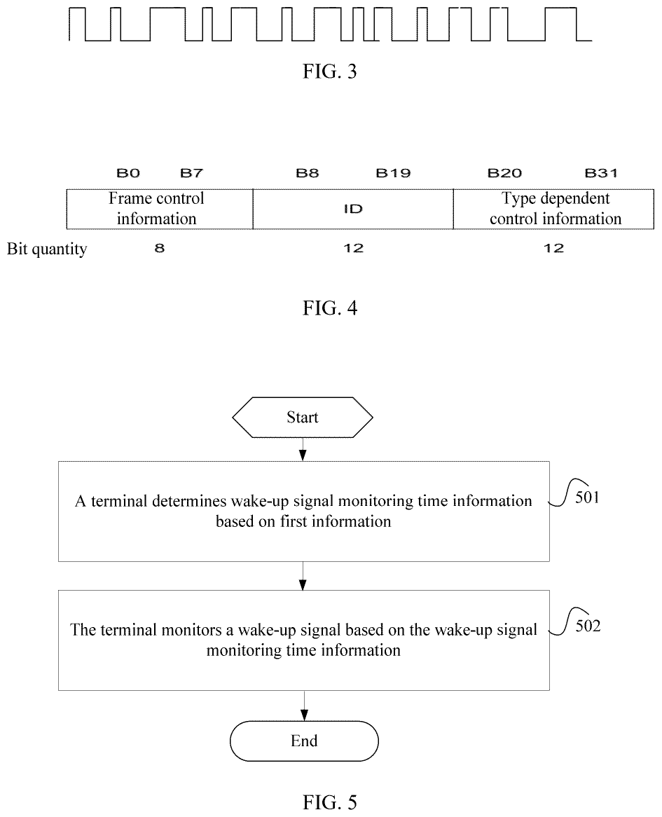

Such wake-up signals are generally some relatively simple on-off keying signals (on-off keying). A time domain pattern of the on-off keying signal is shown in FIG. 3. In this way, the receiver may learn a wake-up notification through processes such as simple energy detection and subsequent possible sequence detection and identification. In addition, while the terminal enables the low power wake-up receiver to receive a wake-up signal, the main receiver module may maintain working at a relatively low power consumption level, thereby implementing power saving by receiving a wake-up signal.

### 3. Beacon Signal

The beacon signal is a periodically sent signal used to transmit time information. The receive end may obtain time synchronization information by receiving a beacon signal. In some embodiments, mobility measurement, channel measurement, or the like may be performed by receiving a beacon signal.

In a related specification, a beacon signal is transmitted by using a specific media access control (MAC) frame, and a structure of the beacon signal is shown in FIG. 4. A WUR beacon is received by using a WUR. Type dependent control of a MAC frame of the WUR beacon carries information about the 5th to the 16th bits in 64 bits of an Aperiodic (AP) Timing Synchronization Function (TSF) clock. After receiving a corresponding information bit, a user updates a local TSF clock of the user based on a time update rule defined by the 802.11ba, so as to achieve synchronization with the AP. A sending periodicity and an offset of a sending start location of the WUR beacon are indicated by an operation element sent by the AP, where the periodicity is a minimum quantity of TSF time units between two times of beacon sending, and the start location is a quantity of TSF time units offset from a TSF 0. When Carrier Sense Multiple Access (CSMA) deferrals occur, WUR beacons are sent in delay in a current periodicity, but are still sent in a subsequent periodicity based on the sending periodicity of the WUR beacon and a location determined based on the sending start location.

With reference to the accompanying drawings, the following describes in detail a wake-up signal monitoring method and apparatus, a wake-up signal monitoring indication method and apparatus, a terminal, and a network side device provided in the embodiments of this application by using some embodiments and application scenarios thereof.

As shown in FIG. 5, an embodiment of this application provides a wake-up signal monitoring method, including:

Step 501: A terminal determines wake-up signal monitoring time information based on first information.

Step 502: The terminal monitors a wake-up signal based on the wake-up signal monitoring time information.

It should be noted that in this embodiment of this application, the wake-up signal includes a low power wake-up signal.

For example, the first information includes at least one of the following parameters: time unit configuration information, wake-up signal configuration information of the terminal, wake-up signal monitoring unit configuration information, beacon signal configuration information, reference time configuration information, monitoring relationship configuration information, paging information, and a first time offset.

A11. Time unit configuration information.

For example, the time unit configuration information includes at least one of the following:

A111. First time unit information, where the first time unit information includes a unit length of a first time unit and timing information of the first time unit.

It should be noted that the first time unit information is used to plan a wake-up signal receiving time unit. In an embodiment, the first time unit is a system frame, that is, a time unit with a length of 10 ms.

A112. Second time unit information, where the second time unit information includes a unit length of a second time unit and timing information of the second time unit, and the length of the first time unit is a multiple of the length of the second time unit.

It should be noted that the length of the first time unit should be greater than the length of the second time unit, that is, the first time unit includes one or more second time units. In an embodiment, the second time unit is a subframe, that is, a time unit with a length of 1 ms.

A113. A numbering periodicity of a first time unit.

It should be noted that the numbering periodicity may also be referred to as an index periodicity. For example, numbers 0 to 1023 are one numbering periodicity.

A114. A first monitoring time unit, where the first monitoring time unit is a first time unit used for wake-up signal monitoring.

A115. A second monitoring time unit, where the second monitoring time unit is a second time unit used for wake-up signal monitoring.

A12. Wake-up signal configuration information of the terminal.

For example, the wake-up signal configuration information includes at least one of the following:

A121. A wake-up signal monitoring periodicity. For example, the wake-up signal monitoring periodicity is related to at least one of the following: a beacon signal periodicity, a paging periodicity, and a wake-up signal sampling periodicity.

A122. Wake-up signal monitoring duration information of the terminal.

It should be noted that if there is a wake-up signal monitoring periodicity, the wake-up signal monitoring duration information is wake-up signal monitoring duration information in one monitoring periodicity. If there is no wake-up signal monitoring periodicity, the wake-up signal monitoring duration information is used to indicate a total time required by the terminal to monitor a wake-up signal.

A13. Wake-up signal monitoring unit configuration information.

For example, the wake-up signal monitoring unit configuration information includes at least one of the following:

A131. First monitoring configuration information, where the first monitoring configuration information includes a time offset of a first monitoring time unit and/or a density of the first monitoring time unit.

For example, the time offset of the first monitoring time unit is a time offset from a starting time of a first reference time unit or a reference beacon signal periodicity indicated by the reference time configuration information.

For example, a value range of the time offset of the first monitoring time unit is from 0 to 1/d1−1, and d1 represents the density of the first monitoring time unit, that is, the value range 0 to 1/d1−1 of the time offset of the first monitoring time unit also includes any integer value of 0 and 1/d1−1.

The density of the first monitoring time unit is obtained by dividing a quantity of first monitoring time units in a wake-up signal monitoring periodicity of the terminal by a quantity of first time units included in the wake-up signal monitoring periodicity of the terminal. It should be noted herein that a time interval between adjacent first monitoring time units can be derived based on the density of the first monitoring time unit.

A132. Second monitoring configuration information, where the second monitoring configuration information includes at least one of a quantity of second monitoring time units in a length of one first monitoring time unit, a time offset of a second monitoring time unit, and a density of the second monitoring time unit.

For example, the time offset of the second monitoring time unit is a time offset from a starting time of the first monitoring time unit. For example, the time offset of the second monitoring time unit is 0. For example, a value range of the time offset of the second monitoring time unit is from 0 to 1/d2−1, and d2 is the density of the second monitoring time unit, that is, the value range 0 to 1/d2−1 of the time offset of the second monitoring time unit also includes any integer value of 0 and 1/d2−1.

The density of the second monitoring time unit is obtained by dividing a quantity of second monitoring time units in a length of one first monitoring time unit by a quantity of second time units in a length of one first monitoring time unit. It should be noted herein that a time interval between adjacent second monitoring time units can be derived based on the density of the second monitoring time unit.

A14. Beacon signal configuration information.

For example, the beacon signal configuration information includes at least one of the following:

A141. A beacon signal periodicity.

It should be noted that the beacon signal periodicity is a beacon signal monitoring periodicity.

A142. Beacon signal periodicity index information.

The beacon signal periodicity index information is index information corresponding to each beacon signal periodicity. For example, the index information may be carried in a data field or a preamble of a beacon signal.

A15. Reference time configuration information.

For example, the reference time configuration information includes at least one of the following:

A151. A first reference time unit of a preset index.

It should be noted that the first reference time unit of the preset index is used as a reference time herein. For example, a first time unit of an index 0 is set as the first reference time unit. In an embodiment, the terminal determines an index of a current first time unit based on the first reference time unit and a time interval from the first reference time unit. In addition, at least one of a wake-up signal periodicity and a beacon signal periodicity may be determined based on the first reference time unit.

A152. A reference beacon signal periodicity of the preset index.

It should be noted that the reference beacon signal periodicity of the preset index is used as a reference time herein. For example, a beacon signal periodicity of an index 0 is set as the reference beacon signal periodicity. In an embodiment, a wake-up signal periodicity may be determined based on the reference beacon signal periodicity. In addition, the reference beacon signal periodicity is associated with the first reference time unit, and the two may be mutually derived.

A16. Monitoring relationship configuration information.

It should be noted that the monitoring relationship configuration information includes at least one of the following:

A161. An identity of the terminal. For example, the identity of the terminal is allocated to the terminal by a network side.

A162. Wake-up signal monitoring group information.

For example, the wake-up signal monitoring group information includes at least one of the following:

A1621. A quantity of first groups for wake-up signal monitoring, where the first group is associated with a first monitoring time unit.

A1622. A quantity of second groups for wake-up signal monitoring, where the second group is associated with a second monitoring time unit.

A163. Configuration information of a wake-up signal monitoring association relationship.

For example, the configuration information of the wake-up signal monitoring association relationship includes at least one of the following:

A1631. An association relationship between a first group and a first monitoring time unit.

A1632. An association relationship between the terminal and the first group.

A1633. An association relationship between a second group and a second monitoring time unit.

A1634. An association relationship between the terminal and the second group.

A1635. An association relationship between the terminal and the first monitoring time unit.

A1636. An association relationship between the terminal and the second monitoring time unit.

A164. Wake-up signal monitoring group identifier information of the terminal.

For example, the wake-up signal monitoring group identifier information of the terminal includes at least one of the following:

A1641. An identifier of a first group to which the terminal belongs.

A1642. An identifier of a second group to which the terminal belongs.

A17. Paging information.

For example, the paging information includes at least one of the following:

A171. A paging periodicity of the terminal.

A172. Timing of a Paging Frame (PF).

For example, the timing of the PF is synchronization information of the paging frame, such as frame synchronization information of the paging frame.

A173. A Paging Frame-offset (PF-offset).

A174. Timing of a Paging Occasion (PO).

For example, the timing of the PO is synchronization information of the paging occasion, such as synchronization information of the paging occasion.

A18. A first time offset.

For example, the first time offset is used to indicate a time interval between a starting time of a PF or a PO of the terminal and a first moment of the wake-up signal monitoring time information of the terminal; and the first moment includes a starting time or an ending time.

For example, the wake-up signal monitoring time information includes at least one of the following:

B11. A wake-up signal monitoring periodicity of the terminal.

B12. Wake-up signal monitoring duration of the terminal.

B13. A first monitoring time unit associated with the terminal.

B14. A second monitoring time unit associated with the terminal.

For example, the first time offset is used to indicate a time interval between the starting time of the PF of the terminal and a starting time of the wake-up signal monitoring periodicity of the terminal. For example, the first time offset is used to indicate a time interval between the starting time of the PO of the terminal and a starting time of the wake-up signal monitoring periodicity of the terminal. For example, the first time offset is used to indicate a time interval between the starting time of the PO of the terminal and a starting time of the wake-up signal monitoring duration. For example, the first time offset is used to indicate a time interval between the starting time of the PO of the terminal and a starting time of the first monitoring time unit associated with the terminal. For example, the first time offset is used to indicate a time interval between the starting time of the PO of the terminal and a starting time of the second monitoring time unit associated with the terminal. It should be noted that the starting time of the PF or the PO and the first moment of the wake-up signal monitoring time information of the terminal are merely examples, and are not intended to constitute a limitation on this application.

For example, a start first time unit of the wake-up signal monitoring time information is determined by the reference time configuration information.

For example, the terminal obtains a wake-up signal monitoring periodicity based on a network configuration, and then determines an index of the first monitoring time unit based on a monitoring association relationship. The index is determined relative to the reference time configuration information. Therefore, a specific location of the start first time unit of the wake-up signal monitoring time information may be determined.

For example, in a case that the first information includes the wake-up signal monitoring periodicity of the terminal, the determining, by a terminal, wake-up signal monitoring time information based on first information includes:
determining, by the terminal, the wake-up signal monitoring periodicity of the terminal based on a wake-up signal monitoring periodicity in the wake-up signal configuration information of the terminal or a paging periodicity of the terminal in the paging information.

It should be noted herein that if Time-Division Multiplexing (TDM) grouping is considered, time domain division may be performed based on a reference time, so that different terminals monitor wake-up signals in different time domains. In an implementation of this application, for a terminal in a Radio Resource Control (RRC) idle (idle) state or an RRC inactive state, in an LP-WUS monitoring state, a low power receiver (that is, a low power receiving module) is enabled and a main receiver (that is, a main communication module) enters a disable state or an ultra-low power standby state, but synchronization of some timing information of the main receiver (main radio), such as a downlink slot or a symbol, is relatively difficult to maintain. In this case, for a terminal in an RRC non-connected state (that is, an RRC idle state or an RRC inactive state), wake-up signal monitoring time information needs to be determined based on a reference time point. In this case, a wake-up signal monitoring periodicity is directly configured for the terminal. In another implementation of this application, it may be assumed that a terminal in an RRC idle state may still maintain timing synchronization when the main radio is in an ultra-deep sleep state in an LP-WUS monitoring state. In this case, when monitoring an LP-WUS, the terminal may perform TDM grouping based on some timing information (for example, paging timing) of the main radio. In addition, in an RRC idle state in the related technology, the main radio needs to perform paging monitoring, and the paging monitoring is also in a TDM grouping manner. Therefore, in this implementation, to reuse paging grouping in the related technology to a maximum extent, the network may perform LP-WUS monitoring grouping configuration based on a paging periodicity of the terminal, and grouping indicated in an LP-WUS may be considered as further grouping of a plurality of terminals associated with a same PO. In this case, the terminal determines the wake-up signal monitoring periodicity of the terminal based on the paging periodicity.

For example, in a case that the first information includes the wake-up signal monitoring duration of the terminal, the determining, by a terminal, wake-up signal monitoring time information based on first information includes:
determining, by the terminal, the wake-up signal monitoring duration of the terminal based on wake-up signal monitoring duration information of the terminal in the wake-up signal configuration information of the terminal.

For example, in this case, the terminal determines the wake-up signal monitoring time information based on a reference time point.

For example, in a case that the first information includes a first monitoring time unit associated with the terminal, the determining, by a terminal, wake-up signal monitoring time information based on first information includes:
determining, by the terminal based on at least one of the time unit configuration information, a wake-up signal monitoring periodicity of the terminal, the wake-up signal monitoring unit configuration information, the beacon signal configuration information, the reference time configuration information, and an association relationship between the terminal and the first monitoring time unit, the first monitoring time unit associated with the terminal, where
the association relationship between the terminal and the first monitoring time unit is determined by the identity of the terminal and the configuration information of the wake-up signal monitoring association relationship; or
the association relationship between the terminal and the first monitoring time unit is determined by the identity of the terminal, the wake-up signal monitoring group information, the configuration information of the wake-up signal monitoring association relationship, and the wake-up signal monitoring group identifier information of the terminal.

In an embodiment, the association relationship between the terminal and the first monitoring time unit may be directly configured for the terminal. In this case, the association relationship between the terminal and the first monitoring time unit should be configured in the configuration information of the wake-up signal monitoring association relationship. The association relationship between the terminal and the first monitoring time unit may also be indirectly obtained by the terminal based on the wake-up signal monitoring group information, the configuration information of the wake-up signal monitoring association relationship, and the wake-up signal monitoring group identifier information of the terminal. In this case, the association relationship between the first group and the first monitoring time unit and the association relationship between the terminal and the first group should be configured in the configuration information of the wake-up signal monitoring association relationship, the identifier of the first group to which the terminal belongs should be configured in the wake-up signal monitoring group identifier information, and the quantity of first groups for wake-up signal monitoring should be configured in the wake-up signal monitoring group information.

For example, in a case that the first information includes a second monitoring time unit associated with the terminal, the determining, by a terminal, wake-up signal monitoring time information based on first information includes:
determining, by the terminal based on at least one of the time unit configuration information, a wake-up signal monitoring periodicity of the terminal, the wake-up signal monitoring unit configuration information, the beacon signal configuration information, the reference time configuration information, and an association relationship between the terminal and the second monitoring time unit, the second monitoring time unit associated with the terminal, where
the association relationship between the terminal and the second monitoring time unit is determined by the identity of the terminal and the configuration information of the wake-up signal monitoring association relationship; or
the association relationship between the terminal and the second monitoring time unit is determined by the identity of the terminal, the wake-up signal monitoring group information, the configuration information of the wake-up signal monitoring association relationship, and the wake-up signal monitoring group identifier information of the terminal.

In an embodiment, the association relationship between the terminal and the second monitoring time unit may be directly configured for the terminal. In this case, the association relationship between the terminal and the second monitoring time unit should be configured in the configuration information of the wake-up signal monitoring association relationship. The association relationship between the terminal and the second monitoring time unit may also be indirectly obtained by the terminal based on the wake-up signal monitoring group information, the configuration information of the wake-up signal monitoring association relationship, and the wake-up signal monitoring group identifier information of the terminal. In this case, the association relationship between the second group and the second monitoring time unit and the association relationship between the terminal and the second group should be configured in the configuration information of the wake-up signal monitoring association relationship, the identifier of the second group to which the terminal belongs should be configured in the wake-up signal monitoring group identifier information, and the quantity of second groups for wake-up signal monitoring should be configured in the wake-up signal monitoring group information.

It should be further noted that in at least one embodiment of this application, the method further includes:
obtaining, by the terminal, the first information, where
the parameters of the first information are configured by a network side device and/or stipulated in a specification.

For example, in a case that the first information is configured by the network side device, the obtaining, by the terminal, the first information includes:
obtaining, by the terminal, some or all parameters of the first information by receiving system information, an RRC message, or Non-Access Stratum (NAS) signaling sent by the network side device.

For example, in at least one embodiment of this application, a specific implementation of the monitoring, by the terminal, a wake-up signal based on the wake-up signal monitoring time information includes:
performing, by the terminal, a first operation in a case that monitoring duration of a beacon signal overlaps monitoring duration of the wake-up signal in terms of time, where
the first operation includes at least one of the following:
skipping monitoring the wake-up signal in an overlapping time; and
monitoring the wake-up signal in a non-overlapping time.

In an embodiment, to avoid time domain overlapping between monitoring duration of a beacon signal and monitoring duration of an LP-WUS, the terminal does not expect to receive the LP-WUS in an overlapping time domain. In other words, the network side device may not send the LP-WUS in the monitoring duration of the beacon signal, or the terminal does not monitor the LP-WUS in the monitoring duration of the beacon signal even if the network side device sends the LP-WUS.

The following uses examples in specific application to describe this embodiment of this application as follows.

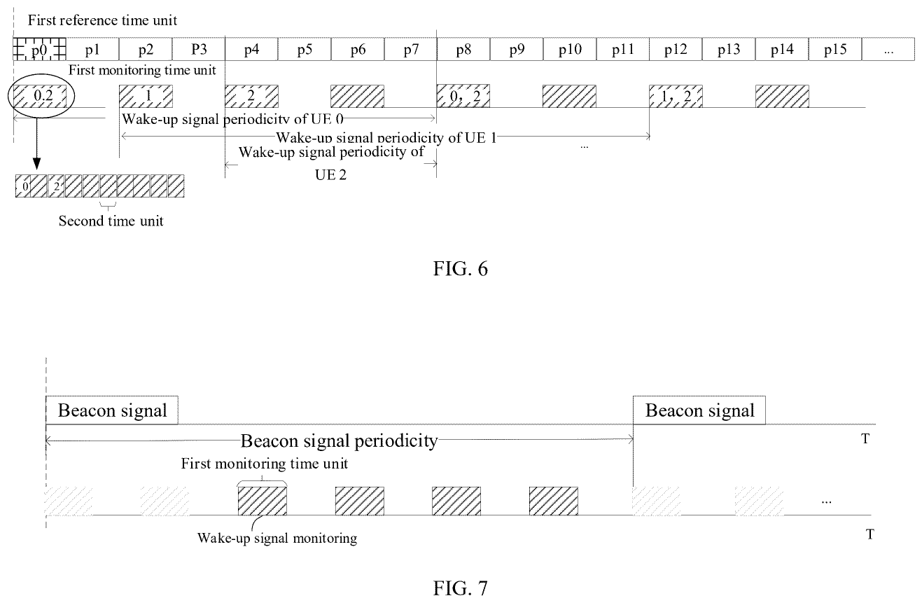

Application case 1: As shown in FIG. 6, a terminal determines an associated first monitoring time unit and an associated second monitoring time unit based on an identity of the terminal and a first reference time unit of a preset index (that is, wake-up signal monitoring time information of the terminal includes the first monitoring time unit associated with the terminal and the second monitoring time unit associated with the terminal). The terminal monitors a wake-up signal based on the wake-up signal monitoring time information.

A network configures and/or a specification stipulates the following parameters in first information of the terminal: identity information of the terminal, wake-up signal configuration information of the terminal, a length of a first time unit, reference time configuration information, a numbering periodicity of a first time unit, wake-up signal monitoring unit configuration information, and configuration information of a wake-up signal monitoring association relationship.

S11. Identity information (UE−ID=2) of the terminal.

S12. Wake-up signal configuration information of the terminal.

A wake-up signal monitoring periodicity (T_{WUS}) of the terminal is four first time units.

S13. A length of a first time unit is 10 ms, that is, a length of an NR system frame.

S14. A length of a second time unit is 1 ms.

S15. Reference time configuration information: a first time unit of an index 0.

S16. A numbering periodicity of a first time unit, for example, 1024 first time units form one numbering periodicity.

S17. Wake-up signal monitoring unit configuration information.

The wake-up signal monitoring unit configuration information includes:

S171. First monitoring configuration information, including a time offset (TU1_{offset}=0) of a first monitoring time unit and a density (d1=1/2) of the first monitoring time unit.

S172. Second monitoring configuration information, including: a quantity (M=10) of second monitoring time units in a length of one first monitoring time unit, a time offset (TU2_{offset}=0) of a second monitoring time unit, and a density (d2=1) of the second monitoring time unit.

S18. Configuration information of a wake-up signal monitoring association relationship.

The configuration information of the wake-up signal monitoring association relationship includes an association relationship between the terminal and the first monitoring time unit and an association relationship between the terminal and the second monitoring time unit. For example, the association relationship may be represented by using formula 1 and formula 2.

$$( {p}_{index} + TU {1}_{offset} ) mod T = ( T div N ) * ( UE\_IDmodN ) . \qquad Formula 1$$

$${q}_{index} = ( {UE}_{ID} mod M ) div d 2 + TU {2}_{offset} . \qquad Formula 2$$

p_{index} is an index of a first time unit for the first reference time unit.
q_{index} is an index of a second time unit in the first monitoring time unit.

T is a wake-up signal periodicity of the terminal, or may be understood as a wake-up signal monitoring periodicity.

N is a quantity of first monitoring time units included in the wake-up signal periodicity of the terminal.

M is a quantity of second monitoring time units included in the first monitoring time unit.

Indexes p_{index} that are of target first time units (that is, first monitoring time units) to be monitored by UE 2 and that are obtained by means of calculation based on the foregoing parameters are p₀, p₄, p₈ . . . , and p₄ₙ, where n is an integer. In each target first time unit that needs to be monitored, an index q_{index} of a target second time unit (that is, a second monitoring time unit) to be monitored by the UE 2 is q₂. The UE 2 performs LP-WUS monitoring on the foregoing time unit. Specific wake-up signal periodicities of different terminals are shown in FIG. 6.

Based on the application case 1, a terminal determines an associated first monitoring time unit and an associated second monitoring time unit based on an identity of the terminal and a first reference time unit of a preset index (that is, wake-up signal monitoring time information of the terminal includes the first monitoring time unit associated with the terminal and the second monitoring time unit associated with the terminal). The terminal monitors a wake-up signal based on the wake-up signal monitoring time information. Therefore, the terminal can monitor a wake-up signal in a monitoring time corresponding to the terminal, and does not need to monitor a wake-up signal in an entire time domain. In this way, a problem of false wake-up caused by the terminal monitoring a wake-up signal used to wake up another terminal due to an overly broad monitoring time can be avoided.

Further, to avoid time domain overlapping between monitoring duration of a beacon and monitoring duration of an LP-WUS, the terminal does not expect to receive the LP-WUS in an overlapping time domain. A specific schematic diagram of monitoring is shown in FIG. 7.

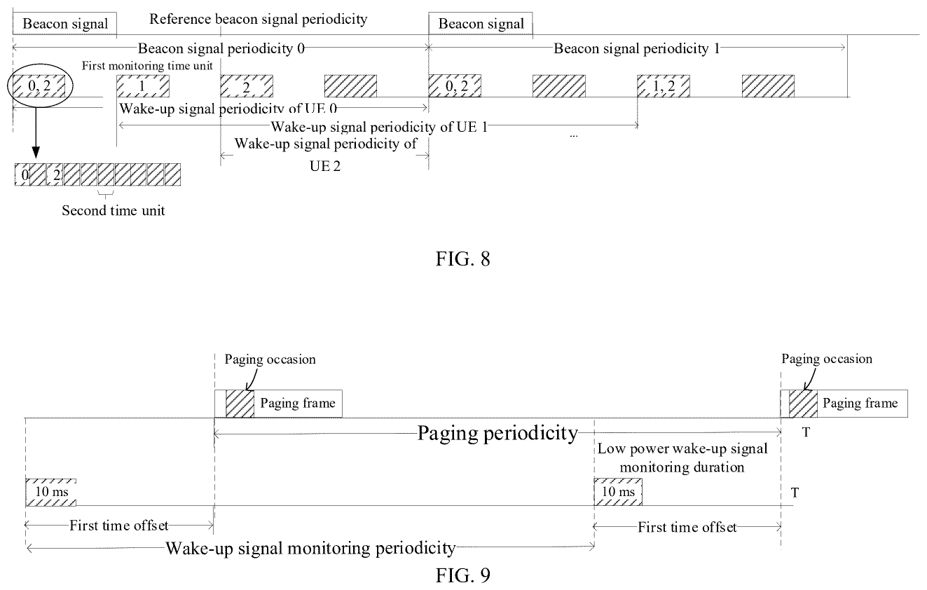

Application case 2: As shown in FIG. 8, a terminal determines an associated first monitoring time unit and an associated second monitoring time unit based on an identity of the terminal and a reference beacon signal periodicity of a preset index (that is, wake-up signal monitoring time information of the terminal includes the first monitoring time unit associated with the terminal and the second monitoring time unit associated with the terminal). The terminal monitors a wake-up signal based on the wake-up signal monitoring time information.

It should be noted that, in this application case, in addition to the following beacon signal configuration information, a beacon signal periodicity of an index 0 in reference time configuration information is used as reference. Other parameters are the same as those of the specific application case 1. In addition, the beacon signal periodicity includes an integer multiple of a first time unit.

For example, the beacon signal configuration information includes:

S21. A beacon signal periodicity (T_{beacon}) is configured as eight first time units.

S22. Beacon signal periodicity index information is index information corresponding to each beacon signal periodicity.

Further, the index information is carried in a data field of a beacon signal.

The terminal may determine, by using a beacon signal periodicity index and a multiple relationship (X) between a beacon signal periodicity and a first time unit, an index value p_{index} corresponding to the first monitoring time unit associated with the terminal. A relationship between a beacon periodicity index (Beaconperiodicity_{index}) and p_{index} is shown in formula 3 to formula 5.

$$( {p}_{index} + TU {1}_{offset} ) mod T = ( T div N ) * ( {UE}_{ID} mod N ) . \qquad Formula 3$$

$${q}_{index} = ( {UE}_{ID} mod M ) div d 2 + TU {2}_{offset} . \qquad Formula 4$$

$$Floor ( {p}_{index} div X ) = {beaconperiodicity}_{index} . \qquad Formula 5$$

For example, for UE 2, when beacon periodicity_{index}=0, p_{index} is 0 and 4, and when beacon periodicity_{index}=1, p_{index} is 8 and 12. Therefore, the UE 2 performs LP-WUS monitoring on the foregoing first reference time unit. Specific wake-up signal periodicities of different terminals are shown in FIG. 8. An effect of the application case 2 is the same as that of the foregoing application case 1, and details are not described herein again.

Application case 3: The terminal determines, based on the paging information and the first time offset, the first monitoring time unit in which the terminal is located/associated with the terminal.

In an embodiment, as shown in FIG. 9, the terminal may still maintain timing of a PO/PF when a main radio is in an ultra-deep sleep state. A low power wake-up signal receiver may interact the timing information with an interface of the main radio. In this scenario, the network may configure the following first information. The terminal determines wake-up signal monitoring time information of the terminal based on the following parameters of the first information. The first information includes at least one of the following parameters: paging information, a first time offset, and wake-up signal configuration information of the terminal.

S31. Paging information.

The paging information includes:

S311. A paging periodicity of the terminal.

S312. Timing of a paging frame PF.

S313. A paging frame offset PF-offset.

S314. Timing of a paging occasion PO.

S32. A first time offset is a time interval between a starting time of a PF of the terminal and a starting time of the first monitoring time unit associated with the terminal, for example, 40 ms.

S33. Wake-up signal configuration information of the terminal.

The wake-up signal configuration information includes:

S331. A wake-up signal monitoring periodicity (T_{WUS}) of the terminal is configured as a paging periodicity of the terminal.

S332. Wake-up signal monitoring duration information of the terminal is configured as 10 ms.

That the terminal may determine the wake-up signal monitoring time information of the terminal through the foregoing information includes:
the wake-up signal monitoring periodicity of the terminal is equal to the paging periodicity of the terminal; and
the wake-up signal monitoring duration information of the terminal is equal to 10 ms.

Therefore, the terminal may determine, based on the paging information and the first time offset, the wake-up signal monitoring time information of the terminal to perform LP-WUS monitoring.

In this application case, grouping indicated in an LP-WUS may be considered as further grouping of a plurality of terminals associated with a same PO, and a specific state of monitoring a wake-up signal by the terminal is shown in FIG. 9.

Application case 4: A process of information exchange between a main communication module and a low power receiving module in a terminal

In the foregoing application case 1 to application case 3, in some application cases, the main communication module of the terminal may transmit some of the first information or the wake-up signal monitoring time information to the low power receiving module through an internal interface.

For example, the main communication module of the terminal stores the first information, for example, at least one of the following parameters: paging receiving related timing information, paging periodicity information, first time unit information, and second time unit information.

S41. Paging receiving related timing information (PF and PO timing information).

S42. Paging periodicity information.

S43. First time unit information (for example, a first time unit is a system frame).

The first time unit information includes:

S431. Timing information of the first time unit.

S432. Length information of the first time unit.

S44. Second time unit information (for example, a second time unit is a subframe).

The second time unit information includes:

S441. Timing information of the second time unit.

S442. Length information of the second time unit.

The information is transmitted to the low power receiving module through the interface, so that the low power receiving module determines time information for wake-up signal monitoring by the terminal.

For another example, the main communication module of the terminal determines time information for wake-up signal monitoring by the terminal based on the first information, and then sends a determined monitoring time to the low power receiver. The low power receiver only needs to monitor a wake-up signal based on the monitoring time.

Further, after receiving the wake-up signal, the low power receiving module triggers the main communication module to switch from a sleep state to a working state. In addition, the low power receiving module may further transmit wake-up signal monitoring information. For example:

The low power receiving module transmits time location information of a monitored wake-up signal relative to a beacon, a type of the monitored wake-up signal, power size information of the monitored wake-up signal, time location information of a beacon signal, and the like to the main communication module, so that the main communication module performs corresponding processing.

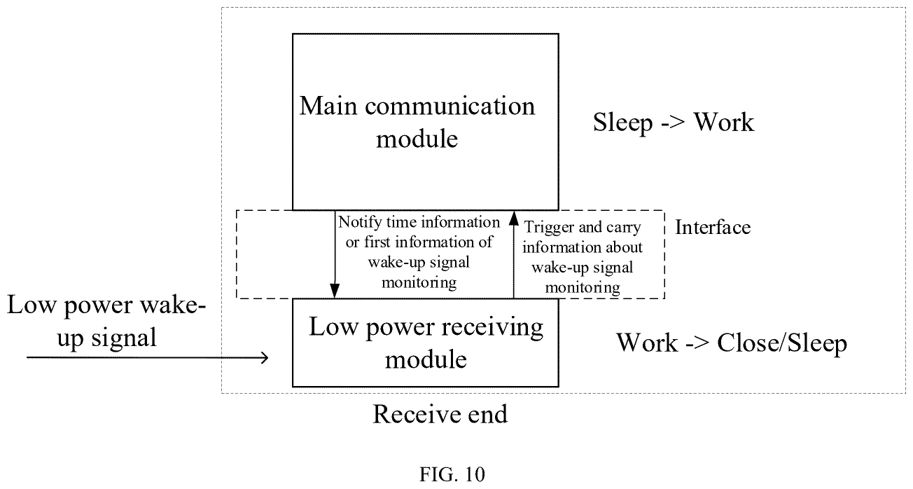

For example, information exchange between the main communication module and the low power receiving module is shown in FIG. 10.

It should be noted that, in at least one embodiment of this application, to prevent a terminal from being mistakenly waked up in a process of detecting an LP-WUS, terminals are grouped in a TDM manner, so that each terminal needs to periodically monitor an LP-WUS in specific duration, and does not need to perform LP-WUS monitoring in an entire time domain. In this way, a problem of false wake-up caused by the terminal monitoring an LP-WUS used to wake up another terminal due to an overly broad monitoring time can be avoided, thereby effectively reducing a false alarm rate (false alarm rate). In addition, in at least one of the embodiments of this application, a time for monitoring an LP-WUS by the terminal is shorter, thereby further reducing power consumption of monitoring an LP-WUS by the terminal.

The wake-up signal monitoring method provided in the embodiments of this application may be performed by a wake-up signal monitoring apparatus. In the embodiments of this application, an example in which the wake-up signal monitoring apparatus performs the wake-up signal monitoring method is used to describe the wake-up signal monitoring apparatus provided in the embodiments of this application.

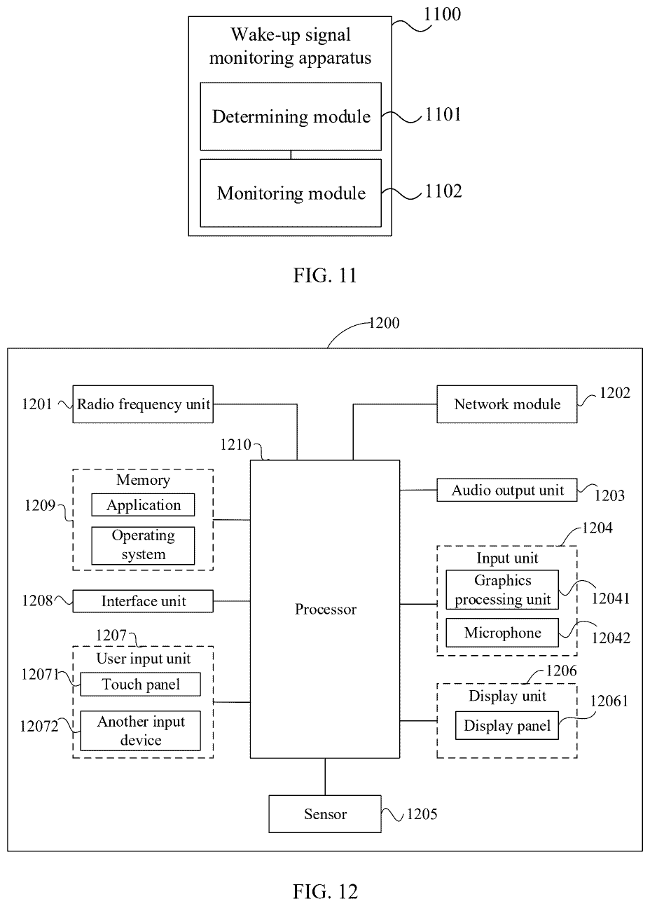

As shown in FIG. 11, a wake-up signal monitoring apparatus 1100 in this embodiment of this application is applied to a terminal and includes:
a determining module 1101, configured to determine wake-up signal monitoring time information based on first information; and
a monitoring module 1102, configured to monitor a wake-up signal based on the wake-up signal monitoring time information, where the wake-up signal includes a low power wake-up signal; and
the first information includes at least one of the following parameters:
time unit configuration information;
wake-up signal configuration information of the terminal;
wake-up signal monitoring unit configuration information;
beacon signal configuration information;
reference time configuration information;
monitoring relationship configuration information;
paging information; and
a first time offset.

For example, the apparatus further includes:
an obtaining module, configured to obtain the first information, where
the parameters of the first information are configured by a network side device and/or stipulated in a specification.

For example, in a case that the first information is configured by the network side device, the obtaining module is configured to:
obtain some or all parameters of the first information by receiving system information, a radio resource control RRC message, or non-access stratum NAS signaling sent by the network side device.

For example, the wake-up signal monitoring time information includes at least one of the following:
a wake-up signal monitoring periodicity of the terminal;
wake-up signal monitoring duration of the terminal;
a first monitoring time unit associated with the terminal; and
a second monitoring time unit associated with the terminal.

For example, a start first time unit of the wake-up signal monitoring time information is determined by the reference time configuration information.

For example, in a case that the first information includes the wake-up signal monitoring periodicity of the terminal, the determining module 1101 is configured to:
determine the wake-up signal monitoring periodicity of the terminal based on a wake-up signal monitoring periodicity in the wake-up signal configuration information of the terminal or a paging periodicity of the terminal in the paging information.

For example, in a case that the first information includes the wake-up signal monitoring duration of the terminal, the determining module 1101 is configured to:
determine the wake-up signal monitoring duration of the terminal based on wake-up signal monitoring duration information of the terminal in the wake-up signal configuration information of the terminal.

For example, the monitoring relationship configuration information includes at least one of the following:
an identity of the terminal;
wake-up signal monitoring group information;
configuration information of a wake-up signal monitoring association relationship; and
wake-up signal monitoring group identifier information of the terminal.

For example, the wake-up signal monitoring group information includes at least one of the following:
a quantity of first groups for wake-up signal monitoring, where the first group is associated with a first monitoring time unit; and
a quantity of second groups for wake-up signal monitoring, where the second group is associated with a second monitoring time unit.

For example, the configuration information of the wake-up signal monitoring association relationship includes at least one of the following:
an association relationship between a first group and a first monitoring time unit;
an association relationship between the terminal and the first group;
an association relationship between a second group and a second monitoring time unit;
an association relationship between the terminal and the second group;
an association relationship between the terminal and the first monitoring time unit; and
an association relationship between the terminal and the second monitoring time unit.

For example, the wake-up signal monitoring group identifier information includes at least one of the following:
an identifier of a first group to which the terminal belongs; and
an identifier of a second group to which the terminal belongs.

For example, in a case that the first information includes a first monitoring time unit associated with the terminal, the determining module 1101 is configured to:
determine, based on at least one of the time unit configuration information, a wake-up signal monitoring periodicity of the terminal, the wake-up signal monitoring unit configuration information, the beacon signal configuration information, the reference time configuration information, and an association relationship between the terminal and the first monitoring time unit, the first monitoring time unit associated with the terminal, where
the association relationship between the terminal and the first monitoring time unit is determined by the identity of the terminal and the configuration information of the wake-up signal monitoring association relationship; or
the association relationship between the terminal and the first monitoring time unit is determined by the identity of the terminal, the wake-up signal monitoring group information, the configuration information of the wake-up signal monitoring association relationship, and the wake-up signal monitoring group identifier information of the terminal.

For example, in a case that the first information includes a second monitoring time unit associated with the terminal, the determining module 1101 is configured to:
determine, based on at least one of the time unit configuration information, a wake-up signal monitoring periodicity of the terminal, the wake-up signal monitoring unit configuration information, the beacon signal configuration information, the reference time configuration information, and an association relationship between the terminal and the second monitoring time unit, the second monitoring time unit associated with the terminal, where
the association relationship between the terminal and the second monitoring time unit is determined by the identity of the terminal and the configuration information of the wake-up signal monitoring association relationship; or
the association relationship between the terminal and the second monitoring time unit is determined by the identity of the terminal, the wake-up signal monitoring group information, the configuration information of the wake-up signal monitoring association relationship, and the wake-up signal monitoring group identifier information of the terminal.

For example, the time unit configuration information includes at least one of the following:
first time unit information, where the first time unit information includes a unit length of a first time unit and timing information of the first time unit;
second time unit information, where the second time unit information includes a unit length of a second time unit and timing information of the second time unit, and the length of the first time unit is a multiple of the length of the second time unit;
a numbering periodicity of a first time unit;
a first monitoring time unit, where the first monitoring time unit is a first time unit used for wake-up signal monitoring; and
a second monitoring time unit, where the second monitoring time unit is a second time unit used for wake-up signal monitoring.

For example, the wake-up signal monitoring unit configuration information includes at least one of the following:
first monitoring configuration information, where the first monitoring configuration information includes a time offset of a first monitoring time unit and/or a density of the first monitoring time unit; and
second monitoring configuration information, where the second monitoring configuration information includes at least one of a quantity of second monitoring time units in a length of one first monitoring time unit, a time offset of a second monitoring time unit, and a density of the second monitoring time unit.

For example, the time offset of the first monitoring time unit is a time offset from a starting time of a first reference time unit or a reference beacon signal periodicity indicated by the reference time configuration information.

For example, the density of the first monitoring time unit is obtained by dividing a quantity of first monitoring time units in a wake-up signal monitoring periodicity of the terminal by a quantity of first time units included in the wake-up signal monitoring periodicity of the terminal.

For example, the time offset of the second monitoring time unit is a time offset from a starting time of the first monitoring time unit.

For example, the density of the second monitoring time unit is obtained by dividing a quantity of second monitoring time units in a length of one first monitoring time unit by a quantity of second time units in a length of one first monitoring time unit.

For example, the beacon signal configuration information includes at least one of the following:
a beacon signal periodicity; and
beacon signal periodicity index information.

For example, the reference time configuration information includes:
a first reference time unit of a preset index; and/or
a reference beacon signal periodicity of the preset index.

For example, the paging information includes at least one of the following: a paging periodicity of the terminal;
timing of a paging frame PF;
a PF offset; and
timing of a paging occasion PO.

For example, the first time offset is used to indicate a time interval between a starting time of a PF or a PO of the terminal and a first moment of the wake-up signal monitoring time information of the terminal; and
the first moment includes a starting time or an ending time.

For example, the monitoring module 1102 is configured to:
perform a first operation in a case that monitoring duration of a beacon signal overlaps monitoring duration of the wake-up signal in terms of time, where
the first operation includes at least one of the following:
skipping monitoring the wake-up signal in an overlapping time; and
monitoring the wake-up signal in a non-overlapping time.

It should be noted that this apparatus embodiment corresponds to the foregoing method, all implementations of the foregoing method embodiment can be applied to this apparatus embodiment, and a same technical effect can be achieved.

The wake-up signal monitoring apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

The wake-up signal monitoring apparatus provided in this embodiment of this application can implement the processes implemented in the method embodiment in FIG. 5, and achieve a same technical effect. To avoid repetition, details are not described herein again.

An embodiment of this application further provides a terminal, including a processor and a communication interface. The processor is configured to determine wake-up signal monitoring time information based on first information; and the communication interface is configured to monitor a wake-up signal based on the wake-up signal monitoring time information, where the wake-up signal includes a low power wake-up signal; and
the first information includes at least one of the following parameters:
time unit configuration information;
wake-up signal configuration information of the terminal;
wake-up signal monitoring unit configuration information;
beacon signal configuration information;
reference time configuration information;
monitoring relationship configuration information;
paging information; and
a first time offset.

For example, the communication interface is further configured to:
obtain the first information, where
the parameters of the first information are configured by a network side device and/or stipulated in a specification.

For example, in a case that the first information is configured by the network side device, the communication interface is configured to:
obtain some or all parameters of the first information by receiving system information, a radio resource control RRC message, or non-access stratum NAS signaling sent by the network side device.

For example, the wake-up signal monitoring time information includes at least one of the following:
a wake-up signal monitoring periodicity of the terminal;
wake-up signal monitoring duration of the terminal;
a first monitoring time unit associated with the terminal; and
a second monitoring time unit associated with the terminal.

For example, a start first time unit of the wake-up signal monitoring time information is determined by the reference time configuration information.

For example, in a case that the first information includes the wake-up signal monitoring periodicity of the terminal, the processor is configured to:
determine the wake-up signal monitoring periodicity of the terminal based on a wake-up signal monitoring periodicity in the wake-up signal configuration information of the terminal or a paging periodicity of the terminal in the paging information.

For example, in a case that the first information includes the wake-up signal monitoring duration of the terminal, the processor is configured to:
determine the wake-up signal monitoring duration of the terminal based on wake-up signal monitoring duration information of the terminal in the wake-up signal configuration information of the terminal.

For example, the monitoring relationship configuration information includes at least one of the following:
an identity of the terminal;
wake-up signal monitoring group information;
configuration information of a wake-up signal monitoring association relationship; and
wake-up signal monitoring group identifier information of the terminal.

For example, the wake-up signal monitoring group information includes at least one of the following:
a quantity of first groups for wake-up signal monitoring, where the first group is associated with a first monitoring time unit; and
a quantity of second groups for wake-up signal monitoring, where the second group is associated with a second monitoring time unit.

For example, the configuration information of the wake-up signal monitoring association relationship includes at least one of the following:
an association relationship between a first group and a first monitoring time unit;
an association relationship between the terminal and the first group;
an association relationship between a second group and a second monitoring time unit;
an association relationship between the terminal and the second group;
an association relationship between the terminal and the first monitoring time unit; and
an association relationship between the terminal and the second monitoring time unit.

For example, the wake-up signal monitoring group identifier information includes at least one of the following:
an identifier of a first group to which the terminal belongs; and
an identifier of a second group to which the terminal belongs.

For example, in a case that the first information includes a first monitoring time unit associated with the terminal, the processor is configured to:
determine, based on at least one of the time unit configuration information, a wake-up signal monitoring periodicity of the terminal, the wake-up signal monitoring unit configuration information, the beacon signal configuration information, the reference time configuration information, and an association relationship between the terminal and the first monitoring time unit, the first monitoring time unit associated with the terminal, where
the association relationship between the terminal and the first monitoring time unit is determined by the identity of the terminal and the configuration information of the wake-up signal monitoring association relationship; or
the association relationship between the terminal and the first monitoring time unit is determined by the identity of the terminal, the wake-up signal monitoring group information, the configuration information of the wake-up signal monitoring association relationship, and the wake-up signal monitoring group identifier information of the terminal.

For example, in a case that the first information includes a second monitoring time unit associated with the terminal, the processor is configured to:
determine, based on at least one of the time unit configuration information, a wake-up signal monitoring periodicity of the terminal, the wake-up signal monitoring unit configuration information, the beacon signal configuration information, the reference time configuration information, and an association relationship between the terminal and the second monitoring time unit, the second monitoring time unit associated with the terminal, where
the association relationship between the terminal and the second monitoring time unit is determined by the identity of the terminal and the configuration information of the wake-up signal monitoring association relationship; or
the association relationship between the terminal and the second monitoring time unit is determined by the identity of the terminal, the wake-up signal monitoring group information, the configuration information of the wake-up signal monitoring association relationship, and the wake-up signal monitoring group identifier information of the terminal.

For example, the time unit configuration information includes at least one of the following:
first time unit information, where the first time unit information includes a unit length of a first time unit and timing information of the first time unit;
second time unit information, where the second time unit information includes a unit length of a second time unit and timing information of the second time unit, and the length of the first time unit is a multiple of the length of the second time unit;
a numbering periodicity of a first time unit;
a first monitoring time unit, where the first monitoring time unit is a first time unit used for wake-up signal monitoring; and
a second monitoring time unit, where the second monitoring time unit is a second time unit used for wake-up signal monitoring.

For example, the wake-up signal monitoring unit configuration information includes at least one of the following:
first monitoring configuration information, where the first monitoring configuration information includes a time offset of a first monitoring time unit and/or a density of the first monitoring time unit; and
second monitoring configuration information, where the second monitoring configuration information includes at least one of a quantity of second monitoring time units in a length of one first monitoring time unit, a time offset of a second monitoring time unit, and a density of the second monitoring time unit.

For example, the time offset of the first monitoring time unit is a time offset from a starting time of a first reference time unit or a reference beacon signal periodicity indicated by the reference time configuration information.

For example, the density of the first monitoring time unit is obtained by dividing a quantity of first monitoring time units in a wake-up signal monitoring periodicity of the terminal by a quantity of first time units included in the wake-up signal monitoring periodicity of the terminal.

For example, the time offset of the second monitoring time unit is a time offset from a starting time of the first monitoring time unit.

For example, the density of the second monitoring time unit is obtained by dividing a quantity of second monitoring time units in a length of one first monitoring time unit by a quantity of second time units in a length of one first monitoring time unit.

For example, the beacon signal configuration information includes at least one of the following:
a beacon signal periodicity; and
beacon signal periodicity index information.

For example, the reference time configuration information includes:
a first reference time unit of a preset index; and/or
a reference beacon signal periodicity of the preset index.

For example, the paging information includes at least one of the following:
a paging periodicity of the terminal;
timing of a paging frame PF;
a PF offset; and
timing of a paging occasion PO.

For example, the first time offset is used to indicate a time interval between a starting time of a PF or a PO of the terminal and a first moment of the wake-up signal monitoring time information of the terminal; and the first moment includes a starting time or an ending time.

For example, the communication interface is configured to:
perform a first operation in a case that monitoring duration of a beacon signal overlaps monitoring duration of the wake-up signal in terms of time, where
the first operation includes at least one of the following:
skipping monitoring the wake-up signal in an overlapping time; and
monitoring the wake-up signal in a non-overlapping time.

This terminal embodiment corresponds to the foregoing method embodiment on the terminal side, each implementation process and implementation of the foregoing method embodiment can be applied to this terminal embodiment, and a same technical effect can be achieved. For example, FIG. 12 is a schematic structural diagram of hardware of a terminal according to an embodiment of this application.

The terminal 1200 includes but is not limited to components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

A person skilled in the art can understand that the terminal 1200 may further include the power supply (for example, a battery) that supplies power to each component. The power supply may be logically connected to the processor 1210 by using a power supply management system, so as to manage functions such as charging, discharging, and power consumption by using the power supply management system. The terminal structure shown in FIG. 12 constitutes no limitation on the terminal, and the terminal may include more or fewer components than those shown in the figure, or combine some components, or have different component arrangements. Details are not described herein.

It should be understood that, in this embodiment of this application, the input unit 1204 may include a Graphics Processing Unit (GPU) 12041 and a microphone 12042, and the graphics processing unit 12041 processes image data of a still image or a video that is obtained by an image capturing apparatus (for example, a camera) in a video capturing mode or an image capturing mode. The display unit 1206 may include a display panel 12061. The display panel 12061 may be configured in a form such as a liquid crystal display or an organic light-emitting diode. The user input unit 1207 includes at least one of a touch panel 12071 and another input device 12072. The touch panel 12071 is also referred to as a touchscreen. The touch panel 12071 may include two parts: a touch detection apparatus and a touch controller. The another input device 12072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1201 may transmit the downlink data to the processor 1210 for processing. In addition, the radio frequency unit 1201 may send uplink data to the network side device. Usually, the radio frequency unit 1201 includes but is not limited to an antenna, an amplifier, a transceiver, a coupler, a low noise amplifier, a duplexer, and the like.

The memory 1209 may be configured to store a software program or an instruction and various data. The memory 1209 may mainly include a first storage area for storing a program or an instruction and a second storage area for storing data. The first storage area may store an operating system, and an application or an instruction required by at least one function (for example, a sound playing function or an image playing function). In addition, the memory 1209 may be a volatile memory or a non-volatile memory, or the memory 1209 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1209 in this embodiment of this application includes but is not limited to these memories and a memory of any other proper type.

The processor 1210 may include one or more processing units. For example, an application processor and a modem processor are integrated into the processor 1210. The application processor mainly processes an operating system, a user interface, an application, and the like. The modem processor mainly processes a wireless communication signal, for example, a baseband processor. It can be understood that, for example, the modem processor may not be integrated into the processor 1210.

The processor 1210 is configured to determine wake-up signal monitoring time information based on first information.

The radio frequency unit 1201 is configured to monitor a wake-up signal based on the wake-up signal monitoring time information, where the wake-up signal includes a low power wake-up signal; and
the first information includes at least one of the following parameters:
time unit configuration information;
wake-up signal configuration information of the terminal;
wake-up signal monitoring unit configuration information;
beacon signal configuration information;
reference time configuration information;
monitoring relationship configuration information;
paging information; and
a first time offset.

Further, the radio frequency unit 1201 is further configured to:
obtain the first information, where
the parameters of the first information are configured by a network side device and/or stipulated in a specification.

For example, in a case that the first information is configured by the network side device, the radio frequency unit 1201 is configured to:
obtain some or all parameters of the first information by receiving system information, a radio resource control RRC message, or non-access stratum NAS signaling sent by the network side device.

For example, the wake-up signal monitoring time information includes at least one of the following:
a wake-up signal monitoring periodicity of the terminal;
wake-up signal monitoring duration of the terminal;
a first monitoring time unit associated with the terminal; and
a second monitoring time unit associated with the terminal.

For example, a start first time unit of the wake-up signal monitoring time information is determined by the reference time configuration information.

For example, in a case that the first information includes the wake-up signal monitoring periodicity of the terminal, the processor 1210 is configured to:
determine the wake-up signal monitoring periodicity of the terminal based on a wake-up signal monitoring periodicity in the wake-up signal configuration information of the terminal or a paging periodicity of the terminal in the paging information.

For example, in a case that the first information includes the wake-up signal monitoring duration of the terminal, the processor 1210 is configured to:
determine the wake-up signal monitoring duration of the terminal based on wake-up signal monitoring duration information of the terminal in the wake-up signal configuration information of the terminal.

For example, the monitoring relationship configuration information includes at least one of the following:
an identity of the terminal;
wake-up signal monitoring group information;
configuration information of a wake-up signal monitoring association relationship; and
wake-up signal monitoring group identifier information of the terminal.

For example, the wake-up signal monitoring group information includes at least one of the following:
a quantity of first groups for wake-up signal monitoring, where the first group is associated with a first monitoring time unit; and
a quantity of second groups for wake-up signal monitoring, where the second group is associated with a second monitoring time unit.

For example, the configuration information of the wake-up signal monitoring association relationship includes at least one of the following:
an association relationship between a first group and a first monitoring time unit;
an association relationship between the terminal and the first group;
an association relationship between a second group and a second monitoring time unit;
an association relationship between the terminal and the second group;
an association relationship between the terminal and the first monitoring time unit; and
an association relationship between the terminal and the second monitoring time unit.

For example, the wake-up signal monitoring group identifier information includes at least one of the following:
an identifier of a first group to which the terminal belongs; and
an identifier of a second group to which the terminal belongs.

For example, in a case that the first information includes a first monitoring time unit associated with the terminal, the processor 1210 is configured to:
determine, based on at least one of the time unit configuration information, a wake-up signal monitoring periodicity of the terminal, the wake-up signal monitoring unit configuration information, the beacon signal configuration information, the reference time configuration information, and an association relationship between the terminal and the first monitoring time unit, the first monitoring time unit associated with the terminal, where
the association relationship between the terminal and the first monitoring time unit is determined by the identity of the terminal and the configuration information of the wake-up signal monitoring association relationship; or
the association relationship between the terminal and the first monitoring time unit is determined by the identity of the terminal, the wake-up signal monitoring group information, the configuration information of the wake-up signal monitoring association relationship, and the wake-up signal monitoring group identifier information of the terminal.

For example, in a case that the first information includes a second monitoring time unit associated with the terminal, the processor 1210 is configured to:
determine, based on at least one of the time unit configuration information, a wake-up signal monitoring periodicity of the terminal, the wake-up signal monitoring unit configuration information, the beacon signal configuration information, the reference time configuration information, and an association relationship between the terminal and the second monitoring time unit, the second monitoring time unit associated with the terminal, where
the association relationship between the terminal and the second monitoring time unit is determined by the identity of the terminal and the configuration information of the wake-up signal monitoring association relationship; or
the association relationship between the terminal and the second monitoring time unit is determined by the identity of the terminal, the wake-up signal monitoring group information, the configuration information of the wake-up signal monitoring association relationship, and the wake-up signal monitoring group identifier information of the terminal.

For example, the time unit configuration information includes at least one of the following:
first time unit information, where the first time unit information includes a unit length of a first time unit and timing information of the first time unit;
second time unit information, where the second time unit information includes a unit length of a second time unit and timing information of the second time unit, and the length of the first time unit is a multiple of the length of the second time unit;
a numbering periodicity of a first time unit;
a first monitoring time unit, where the first monitoring time unit is a first time unit used for wake-up signal monitoring; and
a second monitoring time unit, where the second monitoring time unit is a second time unit used for wake-up signal monitoring.

For example, the wake-up signal monitoring unit configuration information includes at least one of the following:
first monitoring configuration information, where the first monitoring configuration information includes a time offset of a first monitoring time unit and/or a density of the first monitoring time unit; and
second monitoring configuration information, where the second monitoring configuration information includes at least one of a quantity of second monitoring time units in a length of one first monitoring time unit, a time offset of a second monitoring time unit, and a density of the second monitoring time unit.

For example, the time offset of the first monitoring time unit is a time offset from a starting time of a first reference time unit or a reference beacon signal periodicity indicated by the reference time configuration information.

For example, the density of the first monitoring time unit is obtained by dividing a quantity of first monitoring time units in a wake-up signal monitoring periodicity of the terminal by a quantity of first time units included in the wake-up signal monitoring periodicity of the terminal.

For example, the time offset of the second monitoring time unit is a time offset from a starting time of the first monitoring time unit.

For example, the density of the second monitoring time unit is obtained by dividing a quantity of second monitoring time units in a length of one first monitoring time unit by a quantity of second time units in a length of one first monitoring time unit.

For example, the beacon signal configuration information includes at least one of the following:
a beacon signal periodicity; and
beacon signal periodicity index information.

For example, the reference time configuration information includes:
a first reference time unit of a preset index; and/or
a reference beacon signal periodicity of the preset index.

For example, the paging information includes at least one of the following:
a paging periodicity of the terminal;
timing of a paging frame PF;
a PF offset; and
timing of a paging occasion PO.

For example, the first time offset is used to indicate a time interval between a starting time of a PF or a PO of the terminal and a first moment of the wake-up signal monitoring time information of the terminal; and
the first moment includes a starting time or an ending time.

For example, the radio frequency unit 1201 is configured to:
perform a first operation in a case that monitoring duration of a beacon signal overlaps monitoring duration of the wake-up signal in terms of time, where
the first operation includes at least one of the following:
skipping monitoring the wake-up signal in an overlapping time; and
monitoring the wake-up signal in a non-overlapping time.

For example, an embodiment of this application further provides a terminal, including a processor, a memory, and a program or an instruction that is stored in the memory and that can be run on the processor, where the program or the instruction is executed by the processor to implement the processes in the foregoing wake-up signal monitoring method embodiment, and a same technical effect can be achieved. To avoid repetition, details are not described herein again.

An embodiment of this application further provides a readable storage medium. The computer readable storage medium stores a program or an instruction, and the program or the instruction is executed by a processor to implement the processes in the foregoing wake-up signal monitoring method embodiment, and a same technical effect can be achieved. To avoid repetition, details are not described herein again.

The computer readable storage medium includes a Read-Only Memory (ROM for short), a Random Access Memory (RAM), a magnetic disk, an optical disc, or the like.

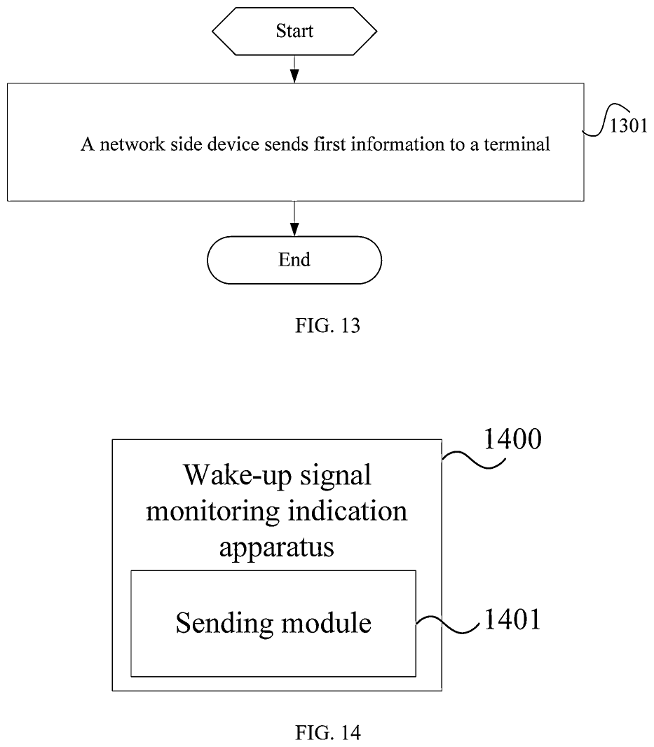

As shown in FIG. 13, an embodiment of this application provides a wake-up signal monitoring indication method, including:

Step 1301: A network side device sends first information to a terminal, where the first information is used by the terminal to determine wake-up signal monitoring time information, and the wake-up signal includes a low power wake-up signal; and
the first information includes at least one of the following parameters:
time unit configuration information;
wake-up signal configuration information of the terminal;
wake-up signal monitoring unit configuration information;
beacon signal configuration information;
reference time configuration information;
monitoring relationship configuration information;
paging information; and
a first time offset.

For example, the sending, by a network side device, first information to a terminal includes:
sending, by the network side device, the first information to the terminal by using system information, a radio resource control RRC message, or non-access stratum NAS signaling.

For example, the monitoring relationship configuration information includes at least one of the following:
an identity of the terminal;
wake-up signal monitoring group information;
configuration information of a wake-up signal monitoring association relationship; and
wake-up signal monitoring group identifier information of the terminal.

For example, the wake-up signal monitoring group information includes at least one of the following:
a quantity of first groups for wake-up signal monitoring, where the first group is associated with a first monitoring time unit; and
a quantity of second groups for wake-up signal monitoring, where the second group is associated with a second monitoring time unit.

For example, the configuration information of the wake-up signal monitoring association relationship includes at least one of the following:
an association relationship between a first group and a first monitoring time unit;
an association relationship between the terminal and the first group;
an association relationship between a second group and a second monitoring time unit;
an association relationship between the terminal and the second group;
an association relationship between the terminal and the first monitoring time unit; and
an association relationship between the terminal and the second monitoring time unit.

For example, the wake-up signal monitoring group identifier information includes at least one of the following:
an identifier of a first group to which the terminal belongs; and
an identifier of a second group to which the terminal belongs.

For example, the time unit configuration information includes at least one of the following:
first time unit information, where the first time unit information includes a unit length of a first time unit and timing information of the first time unit;
second time unit information, where the second time unit information includes a unit length of a second time unit and timing information of the second time unit, and the length of the first time unit is a multiple of the length of the second time unit;
a numbering periodicity of a first time unit;
a first monitoring time unit, where the first monitoring time unit is a first time unit used for wake-up signal monitoring; and
a second monitoring time unit, where the second monitoring time unit is a second time unit used for wake-up signal monitoring.

For example, the wake-up signal monitoring unit configuration information includes at least one of the following:
first monitoring configuration information, where the first monitoring configuration information includes a time offset of a first monitoring time unit and/or a density of the first monitoring time unit; and
second monitoring configuration information, where the second monitoring configuration information includes at least one of a quantity of second monitoring time units in a length of one first monitoring time unit, a time offset of a second monitoring time unit, and a density of the second monitoring time unit.

For example, the time offset of the first monitoring time unit is a time offset from a starting time of a first reference time unit or a reference beacon signal periodicity indicated by the reference time configuration information.

For example, the density of the first monitoring time unit is obtained by dividing a quantity of first monitoring time units in a wake-up signal monitoring periodicity of the terminal by a quantity of first time units included in the wake-up signal monitoring periodicity of the terminal.

For example, the time offset of the second monitoring time unit is a time offset from a starting time of the first monitoring time unit.

For example, the density of the second monitoring time unit is obtained by dividing a quantity of second monitoring time units in a length of one first monitoring time unit by a quantity of second time units in a length of one first monitoring time unit.

For example, the beacon signal configuration information includes at least one of the following:
a beacon signal periodicity; and
beacon signal periodicity index information.

For example, the reference time configuration information includes:
a first reference time unit of a preset index; and/or
a reference beacon signal periodicity of the preset index.

For example, the paging information includes at least one of the following:
a paging periodicity of the terminal;
timing of a paging frame PF;
a PF offset; and
timing of a paging occasion PO.

For example, the first time offset is used to indicate a time interval between a starting time of a PF or a PO of the terminal and a first moment of the wake-up signal monitoring time information of the terminal; and
the first moment includes a starting time or an ending time.

It should be noted that all descriptions about the network side device in the foregoing embodiment can be applied to the embodiment of the wake-up signal monitoring indication method applied to the network side device, and a same technical effect can be achieved. Details are not described herein again.

As shown in FIG. 14, a wake-up signal monitoring indication apparatus 1400 in this embodiment of this application is applied to a network side device and includes:
a sending module 1401, configured to send first information to a terminal, where the first information is used by the terminal to determine wake-up signal monitoring time information, and the wake-up signal includes a low power wake-up signal; and
the first information includes at least one of the following parameters:
time unit configuration information;
wake-up signal configuration information of the terminal;
wake-up signal monitoring unit configuration information;
beacon signal configuration information;
reference time configuration information;
monitoring relationship configuration information;
paging information; and
a first time offset.

For example, the sending module 1401 is configured to:
send the first information to the terminal by using system information, a radio resource control RRC message, or non-access stratum NAS signaling.

For example, the monitoring relationship configuration information includes at least one of the following:
an identity of the terminal;
wake-up signal monitoring group information;
configuration information of a wake-up signal monitoring association relationship; and
wake-up signal monitoring group identifier information of the terminal.

For example, the wake-up signal monitoring group information includes at least one of the following:
a quantity of first groups for wake-up signal monitoring, where the first group is associated with a first monitoring time unit; and
a quantity of second groups for wake-up signal monitoring, where the second group is associated with a second monitoring time unit.

For example, the configuration information of the wake-up signal monitoring association relationship includes at least one of the following:
an association relationship between a first group and a first monitoring time unit;
an association relationship between the terminal and the first group;
an association relationship between a second group and a second monitoring time unit;
an association relationship between the terminal and the second group;
an association relationship between the terminal and the first monitoring time unit; and
an association relationship between the terminal and the second monitoring time unit.

For example, the wake-up signal monitoring group identifier information includes at least one of the following:
an identifier of a first group to which the terminal belongs; and
an identifier of a second group to which the terminal belongs.

For example, the time unit configuration information includes at least one of the following:
first time unit information, where the first time unit information includes a unit length of a first time unit and timing information of the first time unit;
second time unit information, where the second time unit information includes a unit length of a second time unit and timing information of the second time unit, and the length of the first time unit is a multiple of the length of the second time unit;
a numbering periodicity of a first time unit;
a first monitoring time unit, where the first monitoring time unit is a first time unit used for wake-up signal monitoring; and
a second monitoring time unit, where the second monitoring time unit is a second time unit used for wake-up signal monitoring.

For example, the wake-up signal monitoring unit configuration information includes at least one of the following:
first monitoring configuration information, where the first monitoring configuration information includes a time offset of a first monitoring time unit and/or a density of the first monitoring time unit; and
second monitoring configuration information, where the second monitoring configuration information includes at least one of a quantity of second monitoring time units in a length of one first monitoring time unit, a time offset of a second monitoring time unit, and a density of the second monitoring time unit.

For example, the time offset of the first monitoring time unit is a time offset from a starting time of a first reference time unit or a reference beacon signal periodicity indicated by the reference time configuration information.

For example, the density of the first monitoring time unit is obtained by dividing a quantity of first monitoring time units in a wake-up signal monitoring periodicity of the terminal by a quantity of first time units included in the wake-up signal monitoring periodicity of the terminal.

For example, the time offset of the second monitoring time unit is a time offset from a starting time of the first monitoring time unit.

For example, the density of the second monitoring time unit is obtained by dividing a quantity of second monitoring time units in a length of one first monitoring time unit by a quantity of second time units in a length of one first monitoring time unit.

For example, the beacon signal configuration information includes at least one of the following:
a beacon signal periodicity; and
beacon signal periodicity index information.

For example, the reference time configuration information includes:
a first reference time unit of a preset index; and/or
a reference beacon signal periodicity of the preset index.

For example, the paging information includes at least one of the following:
a paging periodicity of the terminal;
timing of a paging frame PF;
a PF offset; and
timing of a paging occasion PO.

For example, the first time offset is used to indicate a time interval between a starting time of a PF or a PO of the terminal and a first moment of the wake-up signal monitoring time information of the terminal; and
the first moment includes a starting time or an ending time.

It should be noted that this apparatus embodiment is an apparatus corresponding to the foregoing method, all implementations of the foregoing method embodiment can be applied to this apparatus embodiment, and a same technical effect can be achieved. Details are not described herein again.

An embodiment of this application further provides a network side device, including a processor and a communication interface. The communication interface is configured to send first information to a terminal, where the first information is used by the terminal to determine wake-up signal monitoring time information, and the wake-up signal includes a low power wake-up signal; and
the first information includes at least one of the following parameters:
time unit configuration information;
wake-up signal configuration information of the terminal;
wake-up signal monitoring unit configuration information;
beacon signal configuration information;
reference time configuration information;
monitoring relationship configuration information;
paging information; and
a first time offset.

For example, the communication interface is configured to:
send the first information to the terminal by using system information, a radio resource control RRC message, or non-access stratum NAS signaling.

For example, the monitoring relationship configuration information includes at least one of the following:
an identity of the terminal;
wake-up signal monitoring group information;
configuration information of a wake-up signal monitoring association relationship; and
wake-up signal monitoring group identifier information of the terminal.

For example, the wake-up signal monitoring group information includes at least one of the following:
a quantity of first groups for wake-up signal monitoring, where the first group is associated with a first monitoring time unit; and
a quantity of second groups for wake-up signal monitoring, where the second group is associated with a second monitoring time unit.

For example, the configuration information of the wake-up signal monitoring association relationship includes at least one of the following:
an association relationship between a first group and a first monitoring time unit;
an association relationship between the terminal and the first group;
an association relationship between a second group and a second monitoring time unit;
an association relationship between the terminal and the second group;
an association relationship between the terminal and the first monitoring time unit; and
an association relationship between the terminal and the second monitoring time unit.

For example, the wake-up signal monitoring group identifier information includes at least one of the following:
an identifier of a first group to which the terminal belongs; and
an identifier of a second group to which the terminal belongs.

For example, the time unit configuration information includes at least one of the following:
first time unit information, where the first time unit information includes a unit length of a first time unit and timing information of the first time unit;
second time unit information, where the second time unit information includes a unit length of a second time unit and timing information of the second time unit, and the length of the first time unit is a multiple of the length of the second time unit;
a numbering periodicity of a first time unit;
a first monitoring time unit, where the first monitoring time unit is a first time unit used for wake-up signal monitoring; and
a second monitoring time unit, where the second monitoring time unit is a second time unit used for wake-up signal monitoring.

For example, the wake-up signal monitoring unit configuration information includes at least one of the following:
first monitoring configuration information, where the first monitoring configuration information includes a time offset of a first monitoring time unit and/or a density of the first monitoring time unit; and
second monitoring configuration information, where the second monitoring configuration information includes at least one of a quantity of second monitoring time units in a length of one first monitoring time unit, a time offset of a second monitoring time unit, and a density of the second monitoring time unit.

For example, the time offset of the first monitoring time unit is a time offset from a starting time of a first reference time unit or a reference beacon signal periodicity indicated by the reference time configuration information.

For example, the density of the first monitoring time unit is obtained by dividing a quantity of first monitoring time units in a wake-up signal monitoring periodicity of the terminal by a quantity of first time units included in the wake-up signal monitoring periodicity of the terminal.

For example, the time offset of the second monitoring time unit is a time offset from a starting time of the first monitoring time unit.

For example, the density of the second monitoring time unit is obtained by dividing a quantity of second monitoring time units in a length of one first monitoring time unit by a quantity of second time units in a length of one first monitoring time unit.

For example, the beacon signal configuration information includes at least one of the following:
a beacon signal periodicity; and
beacon signal periodicity index information.

For example, the reference time configuration information includes:
a first reference time unit of a preset index; and/or
a reference beacon signal periodicity of the preset index.

For example, the paging information includes at least one of the following:
a paging periodicity of the terminal;
timing of a paging frame PF;
a PF offset; and
timing of a paging occasion PO.

For example, the first time offset is used to indicate a time interval between a starting time of a PF or a PO of the terminal and a first moment of the wake-up signal monitoring time information of the terminal; and
the first moment includes a starting time or an ending time.

For example, an embodiment of this application further provides a network side device, including a processor, a memory, and a program or an instruction that is stored in the memory and that can be run on the processor, where the program or the instruction is executed by the processor to implement the processes in the foregoing wake-up signal monitoring indication method embodiment, and a same technical effect can be achieved. To avoid repetition, details are not described herein again.

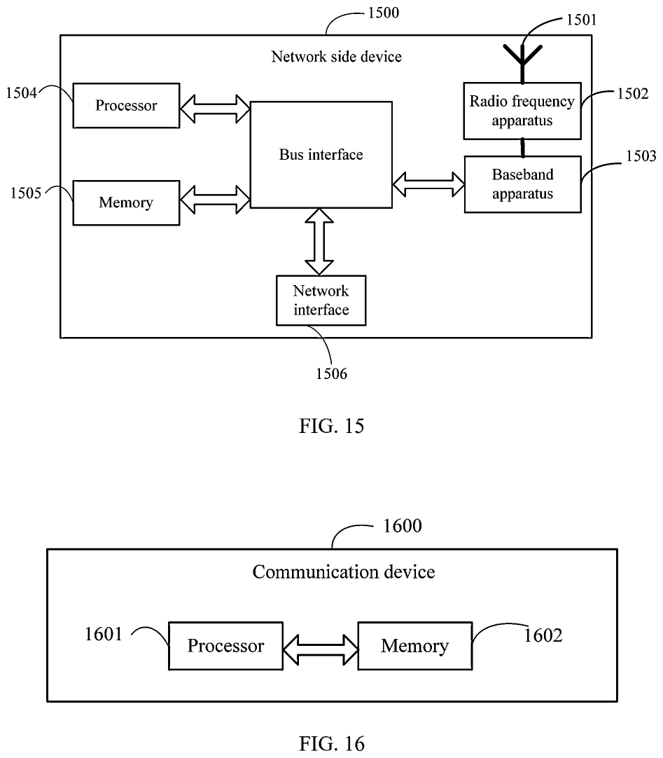

For example, an embodiment of this application further provides a network side device. As shown in FIG. 15, the network side device 1500 includes an antenna 1501, a radio frequency apparatus 1502, a baseband apparatus 1503, a processor 1504, and a memory 1505. The antenna 1501 is connected to the radio frequency apparatus 1502. In an uplink direction, the radio frequency apparatus 1502 receives information by using the antenna 1501, and sends the received information to the baseband apparatus 1503 for processing. In a downlink direction, the baseband apparatus 1503 processes information that needs to be sent, and sends processed information to the radio frequency apparatus 1502. The radio frequency apparatus 1502 processes the received information, and sends processed information by using the antenna 1501.

In the foregoing embodiment, the method performed by the network side device may be implemented in the baseband apparatus 1503. The baseband apparatus 1503 includes a baseband processor.

The baseband apparatus 1503 may include, for example, at least one baseband board, where a plurality of chips are disposed on the baseband board. As shown in FIG. 15, one chip such as the baseband processor is connected to the memory 1505 through a bus interface, to invoke a program in the memory 1505 to perform the operations of the network device shown in the foregoing method embodiment.

The network side device may further include a network interface 1506, and the interface is, for example, a Common Public Radio Interface (CPRI).

For example, the network side device 1500 in this embodiment of the present disclosure further includes an instruction or a program that is stored in the memory 1505 and that can be run on the processor 1504. The processor 1504 invokes the instruction or the program in the memory 1505 to perform the method performed by the modules shown in FIG. 14, and a same technical effect is achieved. To avoid repetition, details are not described herein again.

An embodiment of this application further provides a readable storage medium. The readable storage medium stores a program or an instruction, and the program or the instruction is executed by a processor to implement the processes in the foregoing wake-up signal monitoring indication method embodiment, and a same technical effect can be achieved. To avoid repetition, details are not described herein again.

The processor is a processor in the access network device in the foregoing embodiment. The readable storage medium includes a computer readable storage medium, such as a computer read-only memory ROM, a random access memory RAM, a magnetic disk, or an optical disc.

For example, as shown in FIG. 16, an embodiment of this application further provides a communication device 1600, including a processor 1601 and a memory 1602. The memory 1602 stores a program or an instruction that can be run on the processor 1601. For example, when the communication device 1600 is a terminal, the program or the instruction is executed by the processor 1601 to implement the steps of the foregoing wake-up signal monitoring method embodiment, and a same technical effect can be achieved. When the communication device 1600 is a network side device, the program or the instruction is executed by the processor 1601 to implement the processes of the foregoing wake-up signal monitoring indication method embodiment, and a same technical effect can be achieved. To avoid repetition, details are not described herein again.

An embodiment of this application further provides a chip. The chip includes a processor and a communication interface, the communication interface is coupled to the processor, and the processor is configured to run a program or an instruction to implement the processes of the foregoing wake-up signal monitoring method or wake-up signal monitoring indication method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing wake-up signal monitoring method embodiment, and a same technical effect can be achieved. To avoid repetition, details are not described herein again.

An embodiment of this application further provides a communication system, including a terminal and a network side device. The terminal may be configured to perform the steps of the foregoing wake-up signal monitoring method, and the network side device may be configured to perform the steps of the foregoing wake-up signal monitoring indication method.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In most circumstances, the former is an example implementation manner. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. A wake-up signal monitoring method, comprising:
determining, by a terminal, wake-up signal monitoring time information based on first information; and
monitoring, by the terminal, a wake-up signal based on the wake-up signal monitoring time information, wherein the wake-up signal comprises a low power wake-up signal, and
the first information comprises at least one of the following parameters:
time unit configuration information;
wake-up signal configuration information of the terminal;
wake-up signal monitoring unit configuration information;
beacon signal configuration information;
reference time configuration information;
monitoring relationship configuration information;
paging information; or
a first time offset.

2. The method according to claim 1, further comprising:
obtaining, by the terminal, the first information, wherein
the parameters of the first information are configured by a network side device or stipulated in a specification.

3. The method according to claim 2, wherein when the first information is configured by the network side device, the obtaining, by the terminal, the first information comprises:
obtaining, by the terminal, some or all parameters of the first information by receiving system information, a radio resource control RRC message, or Non-Access Stratum (NAS) signaling sent by the network side device.

4. The method according to claim 1, wherein the wake-up signal monitoring time information comprises at least one of the following:
a wake-up signal monitoring periodicity of the terminal;
wake-up signal monitoring duration of the terminal;
a first monitoring time unit associated with the terminal; or
a second monitoring time unit associated with the terminal.

5. The method according to claim 4, wherein a start first time unit of the wake-up signal monitoring time information is determined by the reference time configuration information.

6. The method according to claim 4, wherein when the first information comprises the wake-up signal monitoring periodicity of the terminal, the determining, by the terminal, the wake-up signal monitoring time information based on first information comprises:
determining, by the terminal, the wake-up signal monitoring periodicity of the terminal based on a wake-up signal monitoring periodicity in the wake-up signal configuration information of the terminal or a paging periodicity of the terminal in the paging information.

7. The method according to claim 4, wherein when the first information comprises the wake-up signal monitoring duration of the terminal, the determining, by the terminal, the wake-up signal monitoring time information based on first information comprises:
determining, by the terminal, the wake-up signal monitoring duration of the terminal based on wake-up signal monitoring duration information of the terminal in the wake-up signal configuration information of the terminal.

8. The method according to claim 1, wherein the monitoring relationship configuration information comprises at least one of the following:
an identity of the terminal;
wake-up signal monitoring group information;
configuration information of a wake-up signal monitoring association relationship; or
wake-up signal monitoring group identifier information of the terminal.

9. The method according to claim 8, wherein the wake-up signal monitoring group information comprises at least one of the following:
a quantity of first groups for wake-up signal monitoring, wherein the first group is associated with a first monitoring time unit; or
a quantity of second groups for wake-up signal monitoring, wherein the second group is associated with a second monitoring time unit, or
the configuration information of the wake-up signal monitoring association relationship comprises at least one of the following:
an association relationship between a first group and a first monitoring time unit;
an association relationship between the terminal and the first group;
an association relationship between a second group and a second monitoring time unit;
an association relationship between the terminal and the second group;
an association relationship between the terminal and the first monitoring time unit; or
an association relationship between the terminal and the second monitoring time unit, or
the wake-up signal monitoring group identifier information comprises at least one of the following:
an identifier of a first group to which the terminal belongs; or
an identifier of a second group to which the terminal belongs.

10. The method according to claim 8, wherein when the first information comprises a first monitoring time unit associated with the terminal, the determining, by the terminal, the wake-up signal monitoring time information based on the first information comprises:
determining, by the terminal based on at least one of the time unit configuration information, a wake-up signal monitoring periodicity of the terminal, the wake-up signal monitoring unit configuration information, the beacon signal configuration information, the reference time configuration information, or an association relationship between the terminal and the first monitoring time unit, the first monitoring time unit associated with the terminal, wherein
the association relationship between the terminal and the first monitoring time unit is determined by the identity of the terminal and the configuration information of the wake-up signal monitoring association relationship; or
the association relationship between the terminal and the first monitoring time unit is determined by the identity of the terminal, the wake-up signal monitoring group information, the configuration information of the wake-up signal monitoring association relationship, and the wake-up signal monitoring group identifier information of the terminal.

11. The method according to claim 8, wherein when the first information comprises a second monitoring time unit associated with the terminal, the determining, by the terminal, the wake-up signal monitoring time information based on the first information comprises:
determining, by the terminal based on at least one of the time unit configuration information, a wake-up signal monitoring periodicity of the terminal, the wake-up signal monitoring unit configuration information, the beacon signal configuration information, the reference time configuration information, or an association relationship between the terminal and the second monitoring time unit, the second monitoring time unit associated with the terminal, wherein
the association relationship between the terminal and the second monitoring time unit is determined by the identity of the terminal and the configuration information of the wake-up signal monitoring association relationship; or
the association relationship between the terminal and the second monitoring time unit is determined by the identity of the terminal, the wake-up signal monitoring group information, the configuration information of the wake-up signal monitoring association relationship, and the wake-up signal monitoring group identifier information of the terminal.

12. The method according to claim 1, wherein the time unit configuration information comprises at least one of the following:
first time unit information, wherein the first time unit information comprises a unit length of a first time unit and timing information of the first time unit;
second time unit information, wherein the second time unit information comprises a unit length of a second time unit and timing information of the second time unit, and the length of the first time unit is a multiple of the length of the second time unit;
a numbering periodicity of a first time unit;
a first monitoring time unit, wherein the first monitoring time unit is a first time unit used for wake-up signal monitoring; or
a second monitoring time unit, wherein the second monitoring time unit is a second time unit used for wake-up signal monitoring, or
the wake-up signal monitoring unit configuration information comprises at least one of the following:
first monitoring configuration information, wherein the first monitoring configuration information comprises a time offset of a first monitoring time unit or a density of the first monitoring time unit; or
second monitoring configuration information, wherein the second monitoring configuration information comprises at least one of a quantity of second monitoring time units in a length of one first monitoring time unit, a time offset of a second monitoring time unit, or a density of the second monitoring time unit.

13. The method according to claim 12, wherein the time offset of the first monitoring time unit is a time offset from a starting time of a first reference time unit or a reference beacon signal periodicity indicated by the reference time configuration information, or
the density of the first monitoring time unit is obtained by dividing a quantity of first monitoring time units in a wake-up signal monitoring periodicity of the terminal by a quantity of first time units comprised in the wake-up signal monitoring periodicity of the terminal, or
the time offset of the second monitoring time unit is a time offset from a starting time of the first monitoring time unit, or
the density of the second monitoring time unit is obtained by dividing a quantity of second monitoring time units in a length of one first monitoring time unit by a quantity of second time units in a length of one first monitoring time unit.

14. The method according to claim 1, wherein the beacon signal configuration information comprises at least one of the following:
a beacon signal periodicity; or
beacon signal periodicity index information, or
the reference time configuration information comprises:
a first reference time unit of a preset index; or
a reference beacon signal periodicity of the preset index, or
the paging information comprises at least one of the following:
a paging periodicity of the terminal;
timing of a Paging Frame (PF);
a PF offset; or
timing of a Paging Occasion (PO).

15. The method according to claim 4, wherein the first time offset is used to indicate a time interval between a starting time of a PF or a PO of the terminal and a first moment of the wake-up signal monitoring time information of the terminal; and
the first moment comprises a starting time or an ending time.

16. The method according to claim 1, wherein the monitoring, by the terminal, the wake-up signal based on the wake-up signal monitoring time information comprises:
performing, by the terminal, a first operation when monitoring duration of a beacon signal overlaps monitoring duration of the wake-up signal in terms of time, wherein
the first operation comprises at least one of the following:
skipping monitoring the wake-up signal in an overlapping time; or
monitoring the wake-up signal in a non-overlapping time.

17. A wake-up signal monitoring indication method, comprising:
sending, by a network side device, first information to a terminal, wherein the first information is used by the terminal to determine wake-up signal monitoring time information, the wake-up signal comprises a low power wake-up signal, and
the first information comprises at least one of the following parameters:
time unit configuration information;
wake-up signal configuration information of the terminal;
wake-up signal monitoring unit configuration information;
beacon signal configuration information;
reference time configuration information;
monitoring relationship configuration information;
paging information; or
a first time offset.

18. The method according to claim 17, wherein the sending, by the network side device, the first information to the terminal comprises:
sending, by the network side device, the first information to the terminal by using system information, a Radio Resource Control (RRC) message, or Non-Access Stratum (NAS) signaling.

19. The method according to claim 17, wherein the monitoring relationship configuration information comprises at least one of the following:
an identity of the terminal;
wake-up signal monitoring group information;
configuration information of a wake-up signal monitoring association relationship; or
wake-up signal monitoring group identifier information of the terminal, or the time unit configuration information comprises at least one of the following:
first time unit information, wherein the first time unit information comprises a unit length of a first time unit and timing information of the first time unit;
second time unit information, wherein the second time unit information comprises a unit length of a second time unit and timing information of the second time unit, and the length of the first time unit is a multiple of the length of the second time unit;
a numbering periodicity of a first time unit;
a first monitoring time unit, wherein the first monitoring time unit is a first time unit used for wake-up signal monitoring; or
a second monitoring time unit, wherein the second monitoring time unit is a second time unit used for wake-up signal monitoring, or
the wake-up signal monitoring unit configuration information comprises at least one of the following:
first monitoring configuration information, wherein the first monitoring configuration information comprises a time offset of a first monitoring time unit or a density of the first monitoring time unit; or
second monitoring configuration information, wherein the second monitoring configuration information comprises at least one of a quantity of second monitoring time units in a length of one first monitoring time unit, a time offset of a second monitoring time unit, or a density of the second monitoring time unit, or
the beacon signal configuration information comprises at least one of the following:
a beacon signal periodicity; or
beacon signal periodicity index information, or
the reference time configuration information comprises:
a first reference time unit of a preset index; or
a reference beacon signal periodicity of the preset index.

20. A terminal, comprising a processor and a memory storing instructions, wherein the instructions, when executed by the processor, cause the processor to perform operations comprising:
determining wake-up signal monitoring time information based on first information; and
monitoring a wake-up signal based on the wake-up signal monitoring time information, wherein the wake-up signal comprises a low power wake-up signal, and
the first information comprises at least one of the following parameters:
time unit configuration information;
wake-up signal configuration information of the terminal;
wake-up signal monitoring unit configuration information;
beacon signal configuration information;
reference time configuration information;
monitoring relationship configuration information;
paging information; or
a first time offset.
